(19) United States
(12) Patent Application Publication
(10) Pub. No.: US 2013/0314790 A1
(43) Pub. Date: Nov. 28, 2013

(54) PATTERNED RETARDER PLATE AND MANUFACTURING METHOD THEREOF

(71) Applicants: Hyuk Jun Kim, Daejeon (KR); Sung Ho Son, Daejeon (KR); Jee Young Ahn, Seoul (KR)

(72) Inventors: Hyuk Jun Kim, Daejeon (KR); Sung Ho Son, Daejeon (KR); Jee Young Ahn, Seoul (KR)

(73) Assignee: SK INNOVATION CO., LTD., Seoul (KR)

(21) Appl. No.: 13/995,567

(22) PCT Filed: Dec. 19, 2011
(86) PCT No.: PCT/KR2011/009779

§ 371 Date: Jul. 30, 2013

(30) Foreign Application Priority Data
Dec. 20, 2010 (KR) 1020100130794

(51) Int. Cl. G02B 5/30

(52) U.S. Cl. CPC G02B 5/3083
USPC 359/489.07; 427/510; 427/504; 427/488

(57) ABSTRACT

Provided is a method for manufacturing a patterned retarder plate including a liquid crystal sheet on which a retarding pattern with a λ/4 wavelength by forming a patterned align layer on a photo align layer by performing an align process once. The method for manufacturing a retarder plate according to the exemplary embodiments of the present invention can implement the photoalign through a single process during the photoalign process using the mask, thereby reducing the defect rate due to the existing method and reducing the process costs.

### TECHNICAL FIELD

The following disclosure relates to a method for manufacturing a patterned retarder plate including a liquid crystal sheet on which a retarding pattern of a λ/4 wavelength by forming a patterned align layer on a photoalign layer by performing an align process once.

### BACKGROUND ART

A three-dimensional image technique may be classified into a stereoscopic technique and an autostereoscopic technique. Further, the stereoscopic technique using a disparity image of left and right eyes having the largest stereoscopic effect is classified into a glasses technique and a non-glasses technique.

The stereoscopic technique has mainly used a retarder plate using a liquid crystal. Generally, the retarder plate using a liquid crystal is configured to include a substrate, an align layer coated on a substrate and subjected to surface align treatment, and a liquid crystal coated and aligned on the align layer. Further, the liquid crystal is aligned on the align layer as a photoreactive liquid crystal and is then crosslinked and solidified by irradiating light such as ultraviolet rays thereto, which generally results in a polymer liquid crystal film type. In addition, an optical axis formed along an align direction of the liquid crystal performs a retarding function based on a surface align direction of the align layer.

At present, the align technique establishes a surface align direction along a rubbing direction by rubbing the align layer using a roll wound with a soft fabric or establishes a surface align direction along the polarization direction by irradiating polarized ultraviolet rays, or the like, to the align layer.

According to the related art, a method for manufacturing a patterned retarder plate using an align layer formed by the above-mentioned technique includes: preparing a substrate; forming an align layer on the substrate; forming patterns on the align layer by a photolithography technique and rubbing and aligning the patterns; removing a photoresist by etching and again forming the patterns by the photolithography technique to rub and align a portion that is not rubbed and aligned; applying a liquid crystal to the align layer on which the patterns are formed; and photo-crosslinking the applied liquid crystal by irradiating light thereto to form a polymer liquid crystal film.

The manufacturing method adopts the rubbing technique and uses the photolithography for forming the patterns and therefore, the manufacturing process is very complicated, the used manufacturing costs are increased, and the defect rate are increased, which results in degrading productivity.

To overcome a disadvantage of the rubbing align technique, a photoalign method that is a non-contact align technique has been developed. A method for manufacturing a retarder plate including an align layer forming process according to the photoalign method of the related art will be described below.

According to the related art, a method for manufacturing a retarder plate using the photoalign method includes: preparing a substrate; forming an align layer on the substrate; disposing a photomask 1 having a predetermined pattern on the align layer and irradiating polarization thereto to perform surface align treatment on only a portion at which light passes through the photomask 1; again disposing a photomask 2 having a predetermined pattern on the align layer that is subjected to the partial surface align treatment and irradiating polarization of which the angle is changed thereto to perform the surface align treatment on only a portion at which light passes through the photomask 2; applying a liquid crystal to the align layer to which is subjected the surface align treatment and photo-crosslinking the applied liquid crystal by irradiating light thereto to form the polymer liquid crystal film.

The technology, which is a two-time mask process (process using a mask twice), uses a method of disposing the photomask 1 on the substrate on which the align layer is formed and primarily photo-aligning the photomask 1 and then, secondarily disposing the photomask 2 thereon and photo-aligning the photomask 2.

The method can originally prevent introduction of dusts by using the photoalign method that is the non-contact align method and can have more excellent productivity than the process of using the rubbing align.

However, the method requires two different photomasks for forming each pattern. When the photomask is aligned for forming each pattern, a region in which the align between the patterns is not defined well is generated at the time of the degradation in the dimension accuracy thereof, such that the quality of the retarder plate may be degraded. When the position align of the mask is wrong, the align of the mask border area may be wrong. That is, at the time of the primarily and secondarily photoalign, a portion where the photoalign is not made any more may be generated or a portion where the photoalign overlaps may be generated.

Further, the photomask align needs to be accurately performed with the high dimension precision and therefore, a tact time may be long during the align process and an expensive facility such as a mask aligner may be required.

In order to solve the problem, KR Patent No. 10-0491752 discloses a method of performing photoalign treatment on the entire region in the same align direction by irradiating polarized ultraviolet rays thereto using a reversible photoreactive material without using the photomask during the primary align process and then, disposing the photomask having a predetermined pattern on a predetermined region during the secondary align process so as to change the align formed during the primary align process in different aligns and re-irradiating light having a changed direction of the polarization axis thereto to manufacture the align layer in which two kinds of align patterns are mixed.

However, in order to manufacture the Patent method, the photoalign treatment process needs to be performed twice or more. Therefore, a reversible photoreactive material, that is, a restricted photoreactive material in which the align direction formed in the first photoalign may be changed to another direction by the following photoalign, the irradiation of ion beam or plasma beam, or rubbing needs to be used. As a result, the manufacturing may be restricted.

### DISCLOSURE

### Technical Problem

An object of the present invention is to provide a method for manufacturing a patterned optical film capable of minimizing a use of a mask during a process of forming patterns on a photoalign layer.

In detail, the present invention has been made in an effort to provide a method for manufacturing a patterned retarder plate capable of reducing manufacturing process and cost by forming a pattern align on a photoalign layer by irradiating light once and forming a retarding pattern of a λ/4 wavelength at the time of coating a liquid crystal in the future, by using a polarizing plate and a patterned retarding mask in which two transmitting axes controlled to 22.5° to −22.5° with respect to the transmitting axis of the polarizing plate are alternately formed.

Further, the present invention has been made in an effort to provide a method for manufacturing a patterned retarder plate without restricting material selection by using both of an reversible material and an irreversible material as a photoalign material at the time of photoalign.

### Technical Solution

In one general aspect, the exemplary embodiment of the present invention for achieving the above problems, which is to solve the problems due to the performance of the align process twice using the existing photomask, relates to a process for manufacturing a patterned retarder plate by performing the photoalign process once using the patterned retarding mask instead of the photomask.

In more detail, the exemplary embodiment of the present invention relates to a method for manufacturing a patterned retarder plate, including:

a) forming a photoalign layer by coating and drying photosensitive polymer compositions on a substrate;

b) forming a patterned photoalign layer by disposing a polarizing plate having a predetermined transmitting axis and a patterned retarding mask on which optical axis of a λ/2 retarding pattern are alternately formed while having an angle difference of 45° from each other over the photoalign layer and by irradiating light from a light source to the patterned retarding mask, the optical axis of the patterned retarding mask being controlled to be 22.5° and −22.5° with respect to the transmitting axis of the polarizing plate;

c) forming a liquid crystal layer by applying a photo crosslinkable liquid crystal to a top portion of the patterned photoalign layer; and

d) forming a liquid crystal sheet formed with an optical axis pattern by photo-crosslinking the liquid crystal layer by irradiating light from a light source thereto.

In another general aspect, in the exemplary embodiment of the present invention, the patterned retarding mask includes:

b1) forming a photoalign layer by coating and drying photosensitive polymer compositions on a substrate;

b2) stacking a polarizing plate on a top portion of the photoalign layer and then, irradiating the light from the light source thereto to perform the primary surface align treatment thereon;

b3) performing secondary align forming an alignment pattern by putting a photomask having transmitting parts spaced from each other at a predetermined distance on the align layer subjected to the primary align treatment, stacking a polarizing plate having a transmitting axis 51 controlled to an angle of 45° with respect to a transmitting axis of the polarizing plate of step b2), and then, irradiating the light from the light source thereto; and

b4) forming a polymer liquid crystal layer by applying the liquid crystal to the align layer subjected to the secondary align treatment and then, irradiating the light from the light source thereto, an optical axis of the retarding pattern of λ/2 of the polymer liquid crystal layer 60 being alternately formed to have an angle difference of 45°.

In the exemplary embodiment of the present invention, the liquid crystal sheet of step d) is formed with a retarding pattern of a λ/4 wavelength to have retarding characteristics.

Other features and aspects will be apparent from the following detailed description, the drawings, and the claims.

### Advantageous Effects

The method for manufacturing a retarder plate according to the exemplary embodiments of the present invention can implement the photoalign through a single process during the photoalign process using the mask, thereby reducing the defect rate due to the existing method and reducing the process costs.

### DESCRIPTION OF DRAWINGS

The above and other objects, features and advantages of the present invention will become apparent from the following description of preferred embodiments given in conjunction with the accompanying drawings, in which:

FIG. 1 shows a process for manufacturing a patterned retarding plate according to an exemplary embodiment of the present invention;

FIG. 2 is a process for manufacturing a patterned retarding mask used for the process for manufacturing a patterned retarder plate according to the exemplary embodiment of the present invention; and

FIG. 3 is a diagram showing a process of implementing photoalign using the patterned retarding mask manufactured by FIG. 2.

[Detailed Description of Main Elements]

| 1: light source | | |
|---|---|---|
| 100: substrate | | |
| 200: photoalign layer 210: patterned photoalign layer | | |
| 211, 212: optical axis | | |
| 300: patterned retarding mask | 311, | 312: |

optical axis

| | |
|---|---|
| 400: polarizing plate | 410: transmitting axis |

| | |
|---|---|
| 500: liquid crystal layer | 510: liquid crystal |

sheet formed with an optical axis pattern

| 10: substrate | |
|---|---|
| 20: photoalign layer | 21: align layer |

subjected to the primary align treatment

| 30: photomask | | |
|---|---|---|
| 40: polarizing plate | 41: | transmitting |

axis

| | | |
|---|---|---|
| 50: polarizing plate | 51: | transmitting |

axis

60: liquid crystal layer

### BEST MODE

Hereinafter, exemplary embodiments of the present invention will be described in detail with reference to the accompanying drawings.

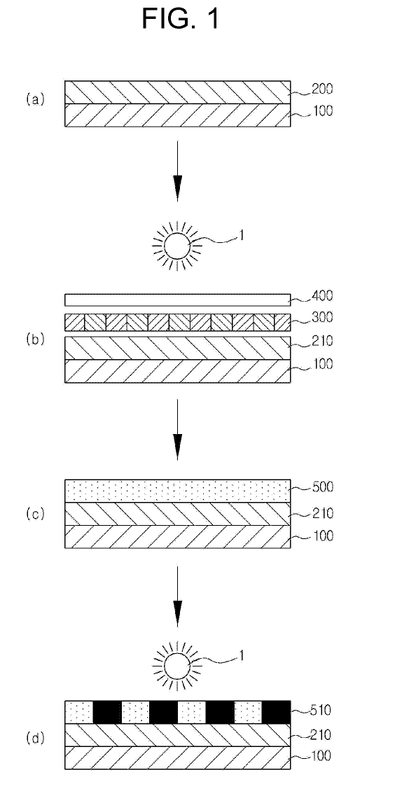

FIG. 1 shows a process for manufacturing a patterned retarding plate according to an exemplary embodiment of the present invention. As shown in FIG. 1, a method for manufacturing a patterned retarder plate includes:

a) forming a photoalign layer 200 by coating and drying photosensitive polymer compositions on a substrate 100;

b) forming a patterned photoalign layer 210 by controlling an optical axis of a patterned retarding mask 300 to be 22.5° and −22.5° with respect to a predetermined transmitting axis of a polarizing plate 400, disposing the patterned retarding mask thereon, and irradiating light from a light source 1 thereto, the optical axis of the patterned retarding mask 300 being alternately formed over the photoalign layer 200 to have an angle difference of 45° with respect to the predetermined transmitting axis of the polarizing plate;

c) forming a liquid crystal layer 500 by applying a photo crosslinkable liquid crystal to a top portion of the patterned photoalign layer 210; and

d) forming a liquid crystal sheet 510 formed with an optical axis pattern by photo-crosslinking the liquid crystal layer 500 by irradiating light from a light source 1 thereto.

According to the exemplary embodiment of the present invention, at step a) the forming of the photoalign layer, a material of the substrate 100 may be used without being restricted if the substrate may be made of a transparent material having optical isotropy such as a polymer film, glass, or the like. Further, it is more preferable to use the substrate having transparency and λ/2 retarding characteristics. Further, the photosensitive polymer compositions forming the photoalign layer 200 may include both of polymer aligned by irreversible reaction and polymer aligned by reversible reaction. In this case, the irreversible reaction means that an align direction of the liquid crystal applied to the photoalign layer is determined by performing surface align treatment by a technique of generating the irreversible reaction such as photo dimerization, photo dissociation, or the like, and then, permanently reforming the surface and the reversible reaction means that the align direction formed in the first photoalign may be changed to another direction by the following photoalign, irradiation of ion beam or plasma beam, or rubbing.

According to the exemplary embodiment of the present invention, at step a), the photoalign layer 200 means a layer obtained by coating and drying the photosensitive polymer compositions. Hereinafter, the patterned photoalign layer 210 may be formed through step b).

A main matter of the exemplary embodiment of the present invention is step b). Here, the polarizing plate 400 is formed over the photoalign layer 200 and the patterned photoalign layer 210 is formed by controlling the optical axis of the patterned retarding mask 300 of a λ/2 wavelength to be 22.5° and −22.5° with respect to the transmitting axis of the polarizing plate to dispose the patterned retarding mask 300 thereon and irradiating the light from the light source 1 thereto to perform pattern align treatment on each patterned retarding region. The align of the patterned photoalign layer 210 has a form alternately photo-aligned at 45° and −45° with respect to the transmitting axis of the polarizing plate.

At step b), the polarizing plate 400 can use a prism polarizing element, an LCD polarizing plate, or the like, in various types such as Glan-thompson, Nicol, Wollaston, or the like.

According to the exemplary embodiment of the present invention, a main matter of step b) is the patterned retarding mask 300 of a λ/2 wavelength stacked on the polarizing plate 400. The exemplary embodiment of the present invention is more advantageous in that the selection of the polymer compositions for forming the patterned photoalign layer is not restricted, as compared with the method of applying the reversible polymer compositions, aligning the compositions in one direction of the front surface thereof without the photomask, and then, partially changing the compositions in another direction using the photomask according to the related art. In addition, the exemplary embodiment of the present invention can solve the problem caused due to a two-time photoalign process by performing a primary photoalign using the photomask after applying the irreversible polymer compositions and then, performing a secondary photoalign using the photomask and the polarizing plate aligned at 90° with respect to the primary photoalign direction.

At step b), the light source 1 may use any one selected from ultraviolet rays, ion beams, and plasma beams.

Next, step c) is a step of forming the liquid crystal layer 500 by applying a photo-crosslinkable liquid crystal to a top portion of the patterned photoalign layer 210 by performing the mask process once at step b). The photo-crosslinkable liquid crystal is at least any one selected from nematic, discotic, and cholesteric liquid crystals, but is not limited if the photo-crosslinkable liquid crystal may be generally used in the art.

In this case, the retarding characteristics vary according to a thickness of the coated liquid crystal and a refractive index anisotropy of the liquid crystal. In the exemplary embodiment of the present invention, the coating is performed at a thickness of several μm or less, more preferably, a thickness at which the retarding pattern of a λ/4 wavelength is formed.

Next, step d) is a step of forming the liquid crystal sheet 510 formed with the optical axis pattern by photo-crosslinking the liquid crystal layer 500 by irradiating the light from the light source 1 thereto. At step d), the light source 1 may use any one selected from ultraviolet rays, ion beams, and plasma beams.

The liquid crystal sheet at step d) is formed with the retarding pattern of a λ/4 wavelength and the patterned retarder plate having the retarding characteristics may be manufactured by steps a) to d).

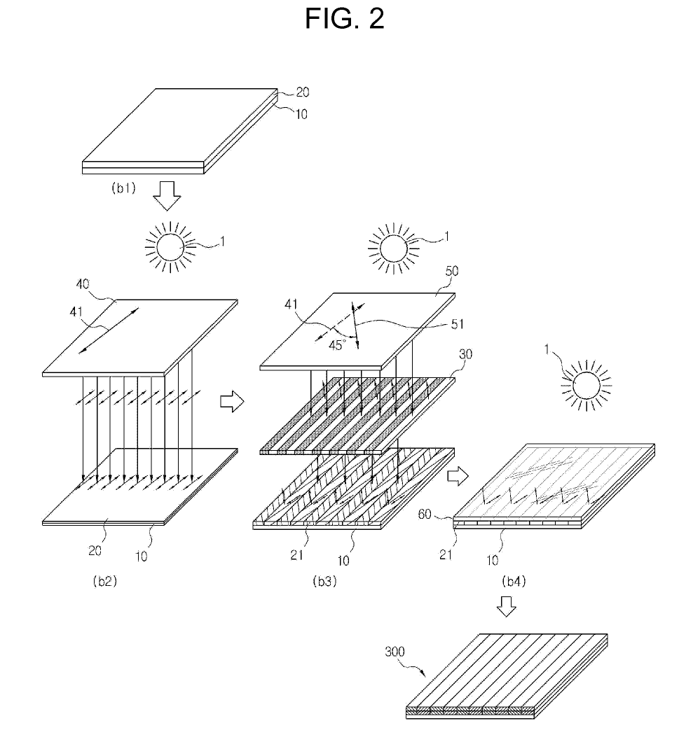

FIG. 2 is a process for manufacturing a patterned retarding mask used for the process for manufacturing a patterned retarder plate according to the exemplary embodiment of the present invention.

As shown in FIG. 2, the patterned retarding mask 300 is manufactured by a method including:

b1) forming a photoalign layer 20 by coating and drying photosensitive polymer compositions on a substrate 10;

b2) stacking a polarizing plate 40 on a top portion of the photoalign layer 20 and then, irradiating the light from the light source 1 thereto to perform the primary surface align treatment thereon;

b3) performing a secondary align forming an align pattern by putting a photomask 30 having transmitting parts spaced from each other at a predetermined distance on the align layer 21 subjected to the primary align treatment, stacking a polarizing plate 40 having a transmitting axis controlled to an angle of 45° with respect to a transmitting axis 41 of the polarizing plate of step b2), and then, irradiating the light from the light source 1 thereto; and

b4) forming a polymer liquid crystal layer 60 by applying the liquid crystal to the align layer 21 subjected to the secondary align treatment and then, irradiating the light from the light source 1 thereto, an optical axis of the pattern of the λ/2 retarding layer of the polymer liquid crystal layer 60 being alternately formed to have an angle difference of 45°.

The patterned retarding mask 300 manufactured by the manufacturing method has a form in which the retarding layer of a λ/2 wavelength is patterned, alternately forming the two transmitting axes controlled to an angle of 45° with respect to the transmitting axis 41 of the polarizing plate 40.

According to the exemplary embodiment of the present invention, the forming of the photoalign layer 20 of step b1), a material of the substrate 10 may be used without being restricted if the substrate may be made of a transparent material having optical isotropy such as a polymer film, glass, or the like. In addition, the photosensitive polymer compositions forming the photoalign layer 20 may preferably use the polymer aligned by the irreversible reaction, but may use the polymer aligned by the reversible reaction. In this case, even at step b2), the photomask 30 having the transmitting parts spaced from each other at a predetermined distance is put and the align pattern is formed. Next, at step b3), a region covered at step b2) is controlled to be transmitted by controlling a position of the photomask 30.

According to the exemplary embodiment of the present invention, at step b1), the photoalign layer 20 means a layer obtained by coating and drying the photosensitive polymer compositions. Hereinafter, the patterned photoalign layer 21 in which the optical axis inclined at an angle of 45° is alternately formed may be formed through steps b2) and b3).

Steps b2) and b3) may be generally performed through a process of forming the secondary photoalign and perform the secondary photoalign by using the polarizing plate 40 having the transmitting axis 41 controlled to an angle of 45° with respect to the transmitting axis 41 of the polarizing plate 40 used for the primary photoalign.

Next, the polymer liquid crystal layer 60 in which the optical axis of the patterns of the retarding layer of λ/2 is alternately formed to have the angle difference of 45° is formed, by applying the liquid crystal thereto to form a liquid crystal layer 60 and then irradiating the light from the light source 1 thereto.

The patterned retarding mask having a structure in which the optical axis is alternately formed, generally having the angle difference of 45° by the manufacturing method can be manufactured.

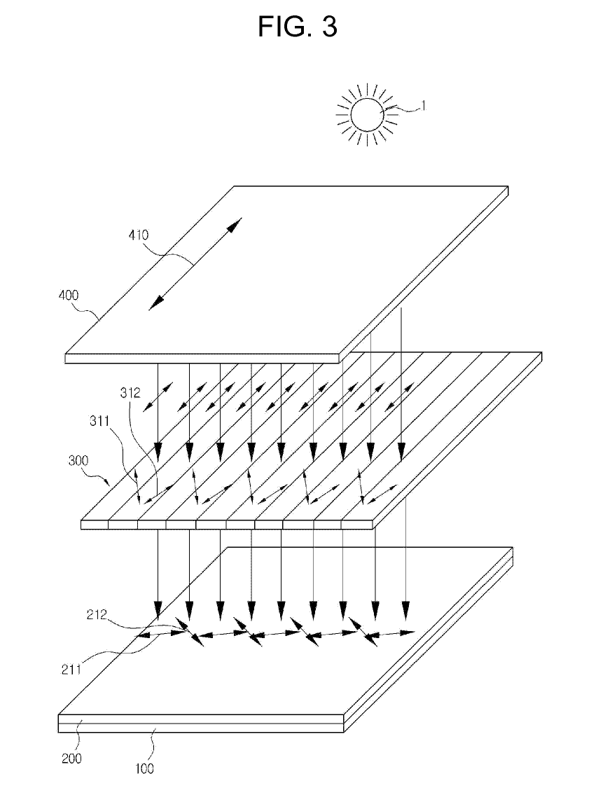

FIG. 3 is a diagram showing step b) of FIG. 1, that is, a process of implementing photoalign using the patterned retarding mask manufactured by FIG. 2.

As shown in FIG. 3, the polarizing plate 400 having a predetermined transmitting axis 410 is formed over the photoalign layer 200 and the retarding mask 300 in which the optical axis of the retarding layer of a 2/λ pattern is alternately patterned while having the angle difference of 45° is disposed thereunder and the light from the light source is irradiated thereto. In this case, the patterned retarding mask 300 in which the optical axes 311 and 312 of the patterned retarding mask 300 are controlled to be 22.5° and −22.5° with respect to the transmitting axis 410 of the polarizing plate is disposed thereunder and the light from the light source 1 is irradiated thereto, such that the optical axes 211 and 212 alternately photo-aligned at 45° and −45° with respect to the transmitting axis 410 of the polarizing plate 400 are formed. That is, the polarization passing through the patterned retarding mask 300 has +45° and −45° with respect to the incident polarization.

In addition, the present invention also provides a polarizing plate for a 3D LCD manufactured using the retarder plate manufactured according to the method of the present invention. Moreover, the present invention also provides a 3D LCD manufactured using the aforesaid polarizing plate.

1. A method for manufacturing a patterned retarder plate, comprising:
a) forming a photoalign layer by coating and drying photosensitive polymer compositions on a substrate;
b) forming a patterned photoalign layer by disposing a polarizing plate having a predetermined transmitting axis and a patterned retarding mask on which optical axis of a λ/2 retarding pattern are alternately formed while having an angle difference of 45° from each other over the photoalign layer and by irradiating light from a light source to the patterned retarding mask, the optical axis of the patterned retarding mask being controlled to be 22.5° and −22.5° with respect to the transmitting axis of the polarizing plate;
c) forming a liquid crystal layer by applying a photo crosslinkable liquid crystal to a top portion of the patterned photoalign layer; and
d) forming a liquid crystal sheet formed with an optical axis pattern by photo-crosslinking the liquid crystal layer by irradiating light from a light source thereto.

2. The method of claim 1, wherein the patterned retarding mask includes:
b1) forming a photoalign layer by coating and drying photosensitive polymer compositions on a substrate;
b2) stacking a polarizing plate on a top portion of the photoalign layer and then, irradiating the light from the light source thereto to perform the primary surface align treatment thereon;
b3) performing secondary align forming an alignment pattern by putting a photomask having transmitting parts spaced from each other at a predetermined distance on the align layer subjected to the primary align treatment, stacking a polarizing plate having a transmitting axis controlled to an angle of 45° with respect to a transmitting axis of the polarizing plate of step b2), and then, irradiating the light from the light source thereto; and
b4) forming a polymer liquid crystal layer by applying the liquid crystal to the align layer subjected to the secondary align treatment and then, irradiating the light from the light source thereto, an optical axis of the retarding patterns of λ/2 of the polymer liquid crystal layer being alternately formed to have an angle difference of 45°.

3. The method of claim 1, wherein the liquid crystal sheet of step d) is formed with a retarding pattern of a λ/4 wavelength to have retarding characteristics.

4. The method of claim 1, wherein at step b), the light source is selected from ultraviolet rays, ion beam, and plasma beam.

5. The method of claim 1, wherein the liquid crystal of step c) is at least any one selected from nematic, discotic, and cholesteric liquid crystals.

6. The method of claim 2, wherein at steps b2) to b4), the light source is selected from ultraviolet rays, ion beam, and plasma beam.

7. The method of claim 2, wherein the liquid crystal of step b4) is at least any one selected from nematic, discotic, and cholesteric liquid crystals.

8. A patterned retarder plate manufactured by the manufacturing method of claim 1.

9. A polarizing plate for a 3D LCD manufactured using the retarder plate of claim 8.

10. A 3D LCD manufactured using the polarizing plate of claim 9.

11. A patterned retarder plate manufactured by the manufacturing method of claim 2.

12. A polarizing plate for a 3D LCD manufactured using the retarder plate of claim 11.

13. A 3D LCD manufactured using the polarizing plate of claim 12.
